(19) United States
(12) Patent Application Publication
(10) Pub. No.: US 2020/0056097 A1
(43) Pub. Date: Feb. 20, 2020

(54) METHOD OF TREATING DRILLING MUD WITH OIL-BASED DRILLING FLUID

(71) Applicants: Wei Ming CHANG, Taoyuan City (TW); Cheng Yin CHANG, Taoyuan City (TW); Jui Ting CHANG, Taoyuan City (TW)

(72) Inventors: Wei Ming CHANG, Taoyuan City (TW); Cheng Yin CHANG, Taoyuan City (TW); Jui Ting CHANG, Taoyuan City (TW)

(21) Appl. No.: 16/103,928

(22) Filed: Aug. 15, 2018

(51) Int. Cl. C10G 1/00; C10G 1/04; B01D 17/02; C02F 9/00; B01D 3/12

(52) U.S. Cl. CPC C10G 1/002; C10G 1/045; B01D 17/0202; C02F 9/00; C02F 1/40; C10G 2300/1007; C10G 2300/1033; C10G 2400/10; B01D 3/12

(57) ABSTRACT

A method of treating drilling mud with oil-based drilling fluid contains: a mud homogenization step configured to homogenize drilling mud which is solidized mud; a 3-phase cyclone separation step in which water vapors are used as a cleaning agent; a petroleum gas oxidation and combustion step in which the petroleum gas is extracted out of the 3-phase separator by using an oil gas oxidation device, and the petroleum gas is thermal oxidized and combusted; a liquid catalyst extraction step executed in which porous substances and hydrocarbon are extracted out of solid waste by using a microbubble extracting and liquid catalyst; a liquid catalyst recycling step having two-stage molecular distillation means so as to recycle the liquid catalyst to the liquid catalyst extraction step and to eliminate the liquid catalyst from recycled base oil. The mud homogenization step is alternatively executed based on physical condition of the drilling mud.

### FIELD OF THE INVENTION

The present invention relates to a method of treating drilling mud of a drilling well, and more particularly to a method of treating drilling mud with oil-based drilling fluid.

### BACKGROUND OF THE INVENTION

A well designed to produce oil or gas is termed an oil well or a gas well. Drill fluid is used to aid the drilling of boreholes into the earth while drilling oil and natural gas wells. The one of drilling fluids is oil-based drilling fluid, such as Shell Saralin V815. Because the wellheads are located in ancient formations, the formation also contains a large number of minerals such as aged soil, illite, montmorillonite, and chlorite. To avoid landslide or collapse while drilling wells, barite or/and xanthan gum are added in drilling well process, thus causing complicated substances of the drilling mud.

Regarding the composition of the drilling mud, in terms of the average value, the drilling mud produced from the oil well has a solid content of 6 to 8%, a water content of 60 to 85%, and an oil content of 10 to 30%. However, the actual composition depends on the actual location of the oil field and the actual conditions of the drilling method.

At present, there are many methods for treating drilling mud in the market. Common methods for treating drilling mud containing oil-based lubricants include: 1). thermal chemical treatment, 2). combustion 3). pyrolysis, and 4). solvent extraction which are described as follows:

1). Thermal chemical treatment is a method of separating oil, water and solid from the drilling mud after adding chemicals into the drilling mud and heating the drilling mud. However, the solid waste has an oily content of up to 2% and is a leachable, thus having secondary pollution.

2). Combustion which means pouring drilling mud into an incinerator, but such a method will cause air pollutions.

3). Pyrolysis which means heats the drilling mud at over 550° C. by using rotary Klin so as to evaporate oil and water from the drilling mud, and the oil and water are recycled by a condenser so as to separate from the drilling mud. However, when the drilling mud has oil-based drilling fluid, the oil, the water, and the oil-based drilling fluid are boiled and evaporated at over 550° C. The recycled oil contains waste water in which waste oil and oil-based drilling fluid contain, so secondary distilling and third distilling are required. Alternatively, a distillation recycle device having multiple-section back distillation mechanisms are provided in Pyrolysis. In addition, the Pyrolysis requires hypoxia indirect oxidation with batch feeding material, thus having high treatment cost.

4). solvent extraction which means adding lipophilic extracting agent into the drilling mud so as to separate oil from the drilling after homogenization and to eliminate hydrocarbon from solid waste of the drilling mud, wherein the oil content of the solid waste is below 0.3%. Nevertheless, the lipophilic extracting agent is expensive (the average unit price is 16 to 30 US dollars per liter), so it is not used widely as producing 1000 kg or MT of drilling mud.

To solve above-mentioned problems, a cyclone separator is employed to separate solid from fluid of the drilling mud, and the fluid is fed to a base oil tank to be gravity separated. Alternatively, a 3-phase separator is applied to separate solid, liquid, and gas of the drilling mud, and the oil is delivered to the base oil tank so as to be gravity separated, and the gas is recycled, waste water is delivered into wastewater treatment plant.

But such a treatment will cause complicated substances of the drilling mud, such as base oil, aged soil, illite, mud, sand, barite powder, oil-based lubricant, and xanthan gum. Furthermore, the cyclone separator or 3-phase cyclone separator cannot eliminate the hydrocarbon (asphaltene and paraffin) from the solid waste totally, and an oil content of the solid waste is at least 2 to 3% (even up to 5-6%). It is easy to result in leaching of hydrocarbon to pollute earth and air.

The residual solid waste is combusted commonly, yet it is easy to produce air pollution and consume useful resources.

The present invention has arisen to mitigate and/or obviate the afore-described disadvantages.

### SUMMARY OF THE INVENTION

One aspect of the present invention is to provide a method of treating drilling mud with oil-based drilling fluid which obtains reusable materials and avoids secondary pollution.

Further aspect of the present invention is to provide a method of treating drilling mud with oil-based drilling fluid which is executed easily and reduces cost.

Another aspect of the present invention is to provide a method of treating drilling mud with oil-based drilling fluid which eliminates hydrocarbon completely from solid waste so as to landfill or solidify the solid waste directly.

To obtain the above aspects, a method of treating drilling mud with oil-based drilling fluid provided by the present invention contains: a mud homogenization step alternatively configured to homogenize drilling mud which is solidized mud.

The mud homogenization step is executed based on physical condition of the drilling mud, when the drilling mud is liquid, the mud homogenization step is eliminated so that the drilling mud is directly delivered to the 3-phase cyclone separation step.

In the mud homogenization step, the drilling mud is fed into a grinder to be ground into particulars, and the particulars of the drilling mud are delivered into a buffer tank and are pumped to a blending tank by a first pump to homogenize the drilling mud; wherein when the drilling mud is solid in the mud homogenization step, condensed oil or diesel oil are added as grinding the drilling mud and mixing the particulars of the drilling mud; a second pump and a third pump deliver the condensed oil or the diesel oil to the grinder and the blending tank respectively from an oil tank.

The method of the present invention further contains:

a 3-phase cyclone separation step in which water vapors are used as a cleaning agent, wherein the drilling mud is flushed and is heated in a cyclone tank of a 3-phase separator so as to dissolve hydrocarbon and to evaporate waste water and petroleum gas, thus separating oil, water, solid waste, and petroleum gas;

a petroleum gas oxidation and combustion step in which the petroleum gas is extracted out of the 3-phase separator by using an oil gas oxidation device, and the petroleum gas is thermal oxidized and combusted;

a liquid catalyst extraction step executed after the 3-phase cyclone separation step, wherein after separating oil and water, solid waste in the 3-phase cyclone separation step has porous substances and the hydrocarbon of high viscosity, and the porous substances and the hydrocarbon are extracted out of the solid waste by using a microbubble extracting of the liquid catalyst extraction step and liquid catalyst;

a liquid catalyst recycling step having two-stage molecular distillation means so as to recycle the liquid catalyst to the liquid catalyst extraction step and to eliminate the liquid catalyst from recycled base oil; and

a wastewater treatment step which is executed after the 3-phase cyclone separation step, wherein the waste water from the 3-phase separator is treated in the wastewater treatment step, and the wastewater treatment step includes oil-water separating, micro-filtrating and attaching, and anion-cation exchanging so as to remove the hydrocarbon from the waste water completely, thus obtaining recyclable effluent.

Preferably, in the 3-phase cyclone separation step, the drilling mud is fed into a preheating tank so as to be heated by a heat pipe on a bottom of the preheating tank, then the drilling mud is delivered to the cyclone tank of a main unit of the 3-phase separator by a fourth pump; meanwhile, water vapors reversely flow into the cyclone tank so as to flush the drilling mud, and oily substances of the drilling mud suspend upward, thereafter the waste water is vaporized to the water vapors, and the water vapors revert into water after flowing through a condensation section of the 3-phase cyclone separator, the water is delivered to the wastewater treatment step by a fifth pump, hydrocarbon C1H4 to C3H8 of the petroleum gas converts into gas at 135° C. so as to suspend upward and to be vacuumed by a vacuum pump, hence the petroleum gas is drawn into a first condenser to be condensed and is pumped to the petroleum gas oxidation and combustion step via a vacuum tank.

### BRIEF DESCRIPTION OF THE DRAWINGS

FIG. 1 is a block diagram showing a method of treating drilling mud with oil-based drilling fluid according to a preferred embodiment of the present invention.

FIG. 2 is a schematic view showing a mud homogenization step of the method according to the preferred embodiment of the present invention.

FIG. 3 is a schematic view showing a 3-phase cyclone separation step of the method according to the preferred embodiment of the present invention.

FIG. 4 is a schematic view showing a petroleum gas oxidation and combustion step of the method according to the preferred embodiment of the present invention.

FIG. 5 is a schematic view showing a liquid catalyst extraction step of the method according to the preferred embodiment of the present invention.

FIG. 6 is a schematic view showing a liquid catalyst recycling step of the method according to the preferred embodiment of the present invention.

FIG. 7 is a schematic view showing a wastewater treatment step of the method according to the preferred embodiment of the present invention.

### DETAILED DESCRIPTION OF THE PREFERRED EMBODIMENTS

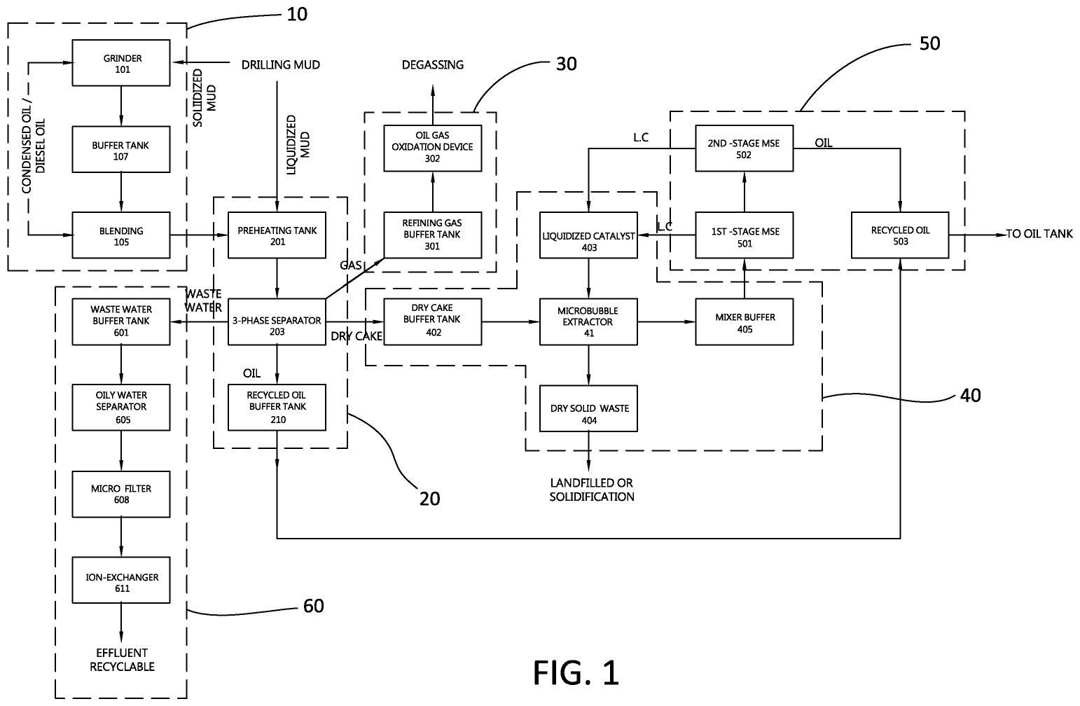

With reference to FIG. 1, a method of treating drilling mud with oil-based drilling fluid according to a preferred embodiment of the present invention comprises: a mud homogenization step 10, a 3-phase cyclone separation step 20, a petroleum gas oxidation and combustion step 30, a liquid catalyst extraction step 40, and a liquid catalyst recycling step 50.

In the mud homogenization step 10, drilling mud is homogenized when it is solidized mud.

In the 3-phase cyclone separation step 20, the drilling mud is heated in a cyclone tank of a 3-phase separator 203 so as to dissolve hydrocarbon and to evaporate waste water and petroleum gas, thus separating oil, water, solid waste, and the petroleum gas.

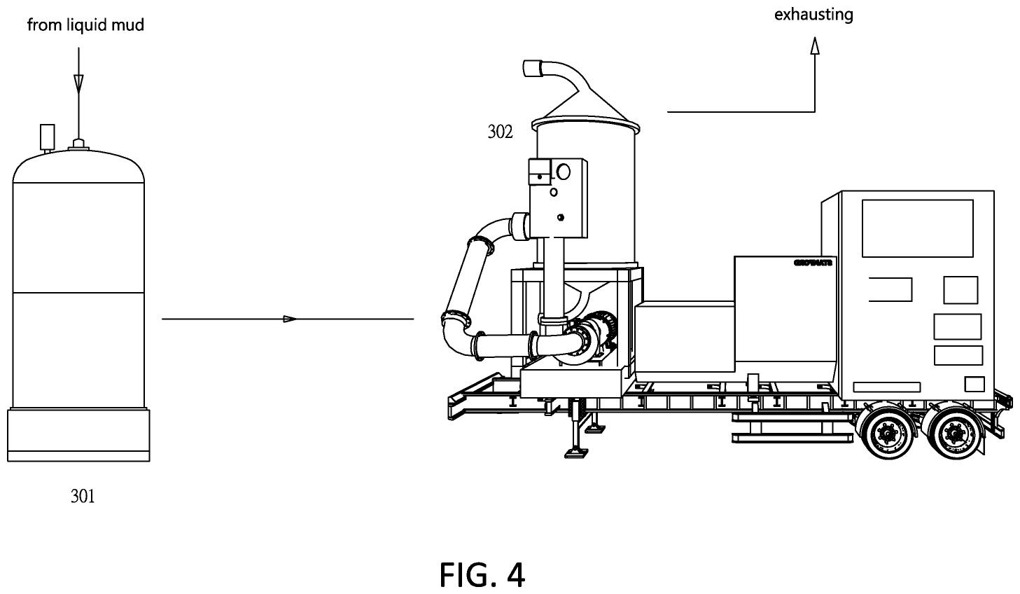

In the petroleum gas oxidation and combustion step 30, the petroleum gas is extracted out of the 3-phase separator 203 by using an oil gas oxidation device 302 (as shown in FIG. 4), and the petroleum gas is thermal oxidized and combusted.

In the liquid catalyst extraction step 40, the solid waste in the 3-phase cyclone separation step 20 has porous substances and hydrocarbon of high viscosity, and the porous substances and the hydrocarbon are extracted out of the solid waste by using a microbubble extracting 41 of the liquid catalyst extraction step 40 and liquid catalyst.

The liquid catalyst recycling step 50 has two-stage molecular distillation means (i.e., a first molecular distilling and a second molecular distilling) so as to recycle the liquid catalyst to the liquid catalyst extraction step 40 and to eliminate the liquid catalyst from recycled base oil.

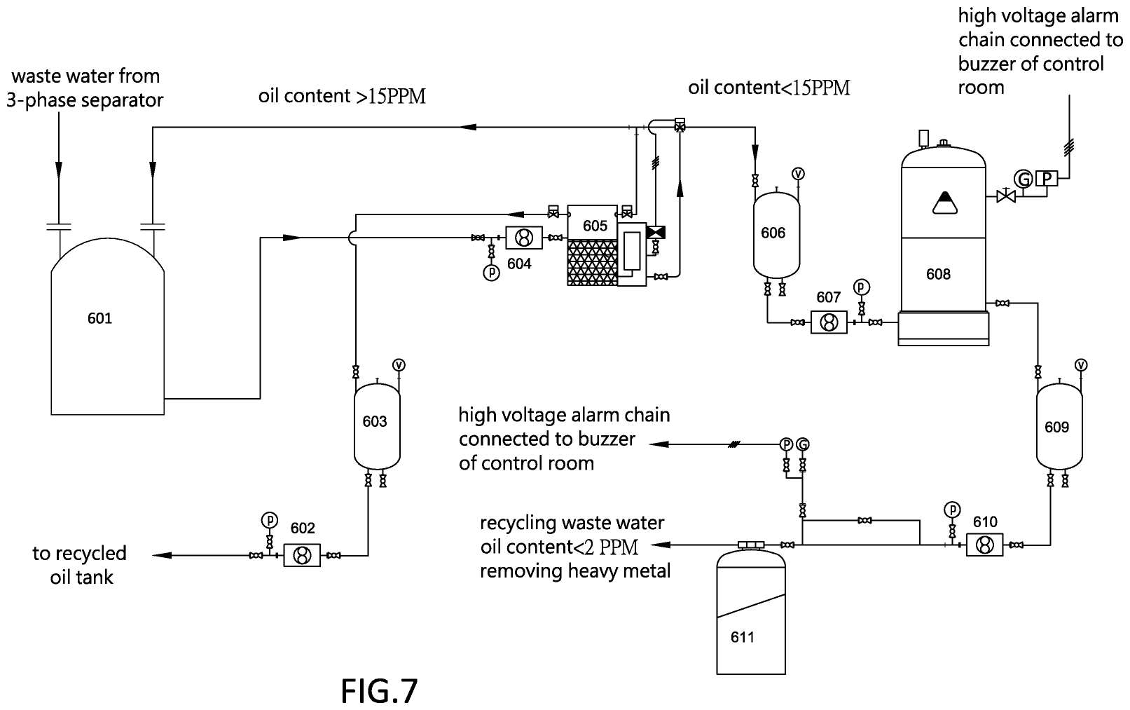

Referring to FIGS. 1 and 7, the method of treating drilling mud further comprises a wastewater treatment step 60 which is executed after the 3-phase cyclone separation step 20, wherein in the wastewater treatment step 60, the waste water from the 3-phase separator 203 is treated, and the wastewater treatment step 60 includes oil-water separating, micro-filtrating and attaching, and anion-cation exchanging so as to remove the hydrocarbon from the waste water completely, thus obtaining recyclable effluent.

When the drilling mud is originally homogeneous before the mud homogenization step 10, it is fed to the 3-phase cyclone separation step 20 without being homogenized in the mud homogenization step 10.

When the drilling mud is nonhomogeneous, it is homogenized in the mud homogenization step 10 and then is fed to the 3-phase cyclone separation step 20.

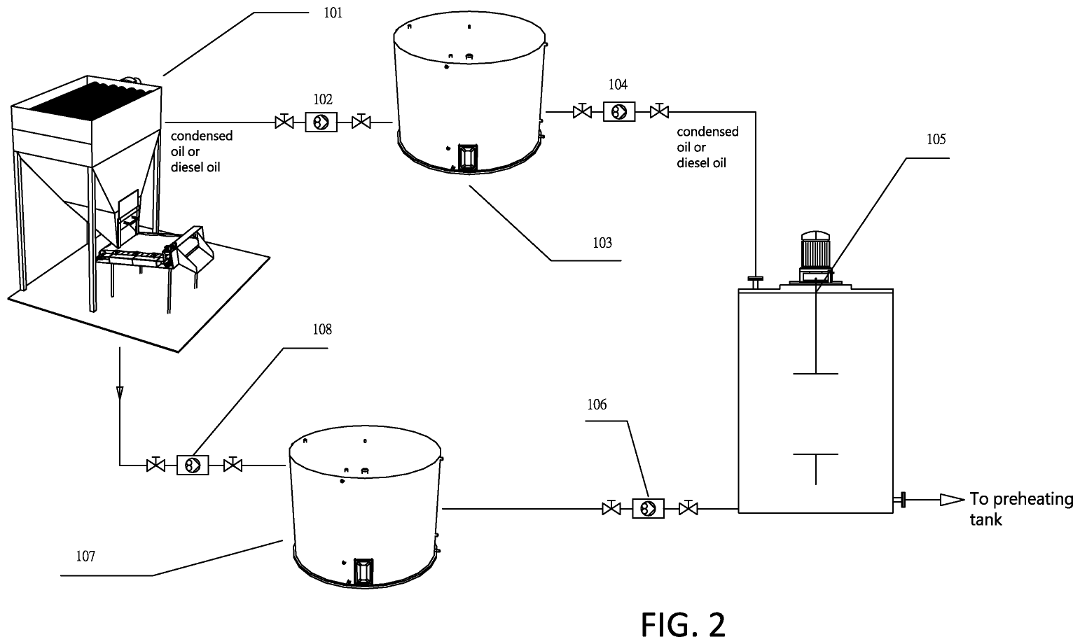

As shown in FIGS. 1 and 2, in the mud homogenization step 10, the drilling mud in an oil pit or a woven bag is homogenized to convert into fluid from solid. When the drilling mud is fluid originally, it is fed to the 3-phase cyclone separation step 20 without being homogenized in the mud homogenization step 10.

In the mud homogenization step 10, the drilling mud is solid and is fed into a grinder 101 to be ground into particulars of 2-3 mm diameter, the particulars of the drilling mud are delivered into a buffer tank 107 and are pumped to a blending tank 105 by a first pump 106, thus homogenizing the drilling mud.

When the drilling mud is solid in the mud homogenization step 10, condensed oil or diesel oil are added as grinding the drilling mud and mixing the particulars of the drilling mud.

A second pump 102 and a third pump 104 deliver the condensed oil or the diesel oil to the grinder 101 and the blending tank 105 respectively from an oil tank 103.

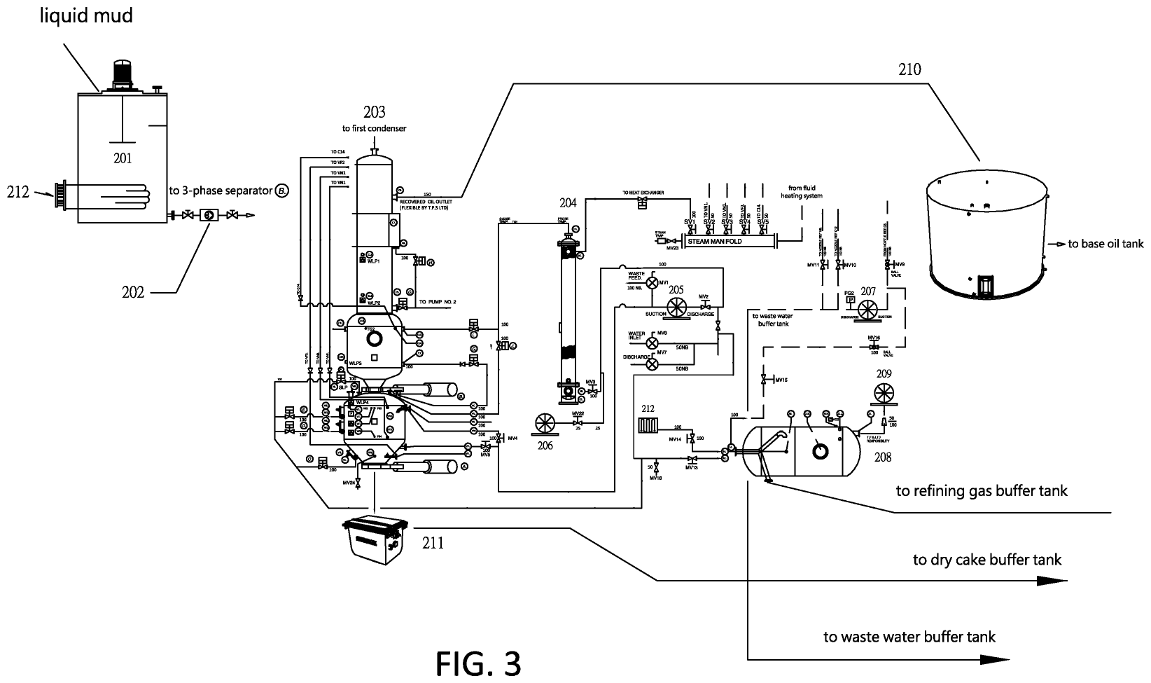

As illustrated in FIGS. 1 and 3, in the 3-phase cyclone separation step 20, the drilling mud is fed into a preheating tank 201 so as to be heated by a heat pipe 2011 on a bottom of the preheating tank 201 at 135° C. Then, the drilling mud is delivered to the cyclone tank of a main unit of the 3-phase separator 203 by a fourth pump 202. In the meantime time, water vapors reversely flow into the cyclone tank so as to flush the drilling mud, and oily substances of the drilling mud suspend upward. Thereafter, the waste water is vaporized to the water vapors at 135° C., and the water vapors revert into water after flowing through a condensation section of the 3-phase cyclone separator 203. The water is delivered to the wastewater treatment step 60 by a fifth pump. Hydrocarbon C1H4 to C3H8 of the petroleum gas converts into gas at 135° C. so as to suspend upward and to be vacuumed by a vacuum pump 209, hence the petroleum gas is drawn into a first condenser 212 to be condensed and is pumped to the petroleum gas oxidation and combustion step 30 via a vacuum tank 208.

The solid waste accumulates on a bottom of the 3-phase separator 203 in the 3-phase cyclone separation step 20 so that after a knife gate valve on the bottom of the 3-phase separator 203 turns on, the solid waste drops into a first storage tank 211. Furthermore, recycled oil is fed into a recycled oil buffer tank 210 so as to be delivered into a base oil tank after it is full of the recycled oil buffer tank 210.

A heat exchanger 204, a sixth pump 205, a seventh pump 207, and the first condenser 212 are provided in the 3-phase cyclone separation step 20 based on Zone 1 using requirement. The 3-phase separator 203 and its peripherals are manufactured according to zxplosion-proof requirement of NEMA or ATex IIB T4/T5.

With reference to FIGS. 1 and 4, the petroleum gas oxidation and combustion step 30 is executed after the 3-phase cyclone separation step 20. For example, waste petroleum gas extracted out of the 3-phase cyclone separation step 20 by using an exhauster of the oil gas oxidation device 302 is guided into a refining gas buffer tank 301, and the waste petroleum gas is drawn into an oxidation tank of the oil gas oxidation device 302 to be combusted and is discharged out of atmosphere via an discharge device.

When an oxidation temperature of the petroleum gas does not reach a set temperature, an intake valve of the oil gas oxidation device 302 turns on automatically so as to guide propane gas to mix with the waste petroleum gas, such that the waste petroleum gas is oxidized and combusted in the oil gas oxidation device 302 so as to exhaust petroleum gas.

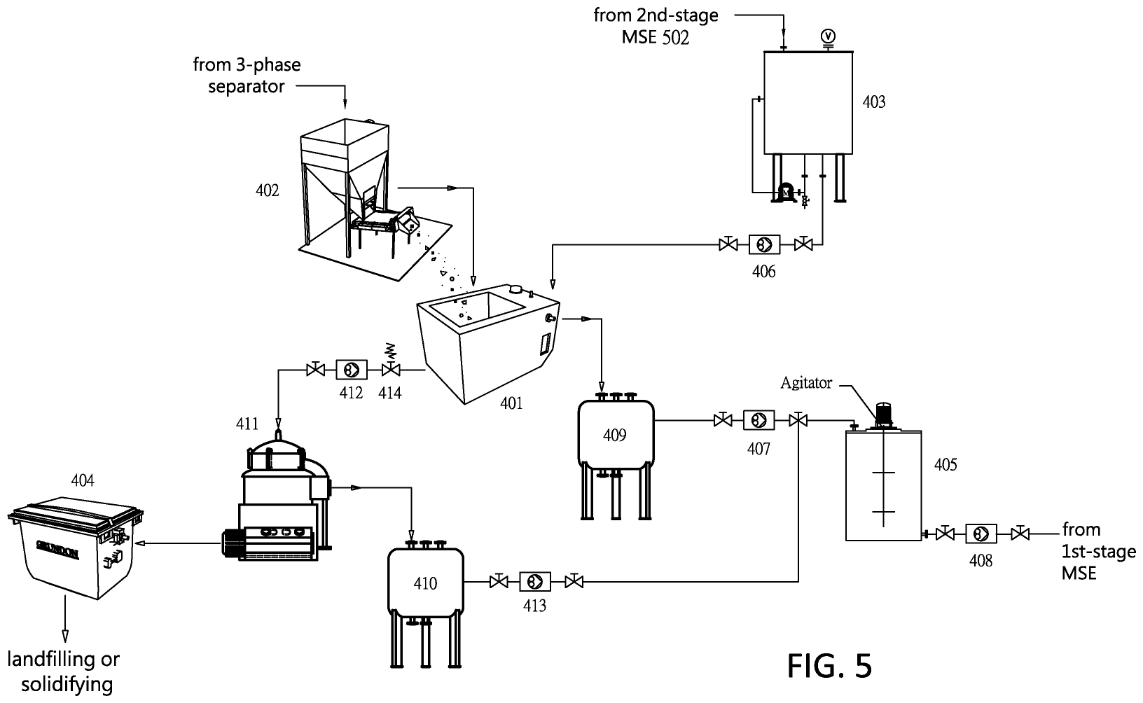

Referring to FIGS. 1 and 5, hydrocarbon (including asphaltene, paraffin, and other substances) in residual solids from the 3-phase cyclone separation step 20 is dissolved and extracted by ways of the microbubble extracting 41 of the liquid catalyst extraction step 40 and the liquid catalyst, thus landfilling and solidifying the solid waste.

The residual solids discharged by the main unit of the 3-phase separator 203 is delivered to a dry cake buffer tank 402 and is carried into a processing tank of a microbubble extractor 401 via a conveyor. In the meantime, the liquid catalyst is added into the processing tank in a predetermined fluid level, and a microbubble generator is started to spray microbubbles of 20 micron (00.02 mm) out of a nozzle of the microbubble generator to flush the residual solids, hence a part of microbubbles in which the liquid catalyst is carried flows into bores of the solid waste, thus dissolving and washing the hydrocarbon (inclusive of asphaltene and paraffin) in the bores and producing mixture of the hydrocarbon and the liquid catalyst. Thereafter, an eighth pump 406 delivers the liquid catalyst into a washing tank of the microbubble extractor 401 from a liquidized catalyst tank 403 after feeding the solid waste continuously based on 0.5% weight of the residual solids, wherein the mixture of the hydrocarbon and the liquid catalyst above a highest fluid level increases and overflows into a second storage tank, and a ninth pump 407 pumps the mixture to a mixer buffer tank 405 and is delivered to the liquid catalyst recycling step 50 by a tenth pump 408.

The solid waste deposits in an extraction tank after being extracted in the liquid catalyst extraction step 40, and a controller sends a signal to stop feeding residual solids after ten minutes. An electromagnetic valve 414 is turned on so that the residual solids are delivered into a centrifugal separator 411 by an eleventh pump 412 so as to separate solid and fluid from the residual solids. Thereafter, the residual solids are pushed into an dry solid waste tank 404, and fluid (inclusive of the mixture of the hydrocarbon and the liquid catalyst) is guided into a third storage tank 410 and is delivered to the mixer buffer tank 405 by a twelfth pump 413. After separating the solid and the fluid from the residual solids for five minutes, the electromagnetic valve is turned off. Then, the residual solids are fed from the dry cake buffer tank 402, and the liquid catalyst is fed into the microbubble extractor 401 from the liquidized catalyst tank 403 until reaching the predetermined fluid level, thereafter the microbubble extractor 401 starts operation again to have extracting process.

The microbubble extracting 41 of the liquid catalyst extraction step 40 flushes and extracts the hydrocarbon from the solid waste by using the liquid catalyst, thus eliminating the hydrocarbon from the residual solids in the 3-phase cyclone separation step 20 to acquire the drilling mud with the oil-based drilling fluid.

Accordingly, the solid waste does not remain asphaltene and paraffin and is accommodated in the dry solid waste tank 404 so as to be buried or solidified.

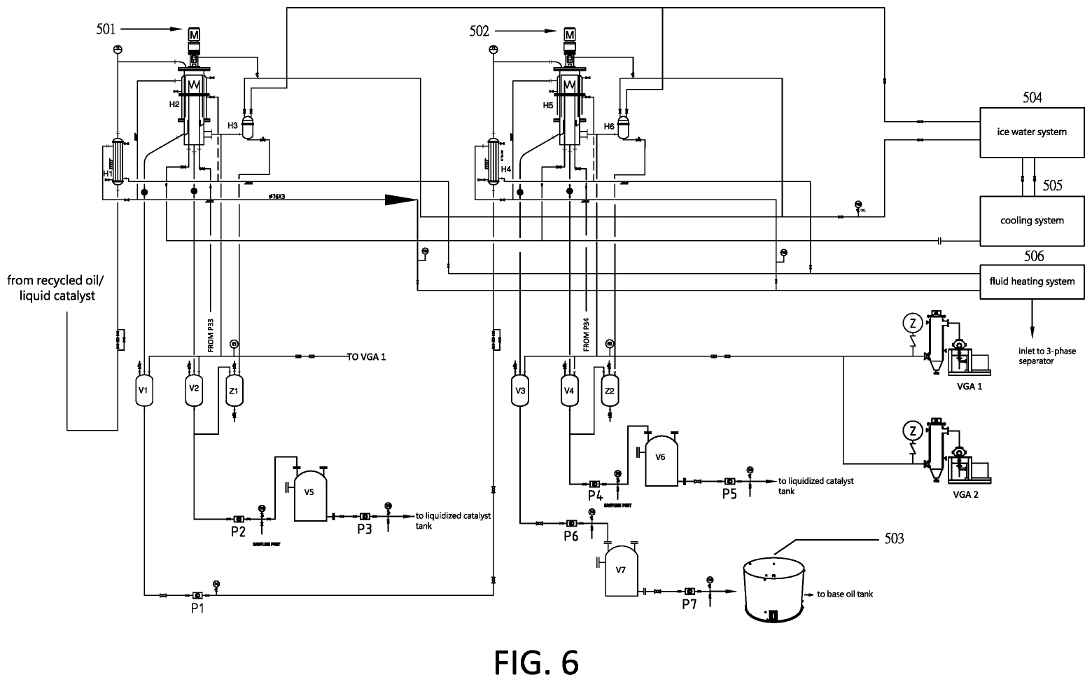

As shown in FIGS. 1 and 6, the liquid catalyst recycling step 50 is executed after the liquid catalyst extraction step 40, and a 1^{st}-stage MSE 501 and a 2^{nd}-stage MSE 502 are provided in the first molecular distilling and the second molecular distilling respectively.

The tenth pump 408 carries the liquid catalyst and recycled oil mixture to a first preheater H1 so as to heat the liquid catalyst and recycled oil mixture at 60° C., and the liquid catalyst and the recycled oil mixture enter into the 1^{st}-stage MSE 501 so as to be scraped by a scraper of the 1^{st}-stage MSE 501 into a film of 0.5 mm-1 mm Since an external vacuum pump VGA-1 or VGA-2 vacuums the 1^{st}-stage MSE 501 via a conduit of a cold well, a pressure of the 1^{st}-stage MSE 501 maintains less than 100 Pa so that a part of mixing fluid attaching on the film of an inner wall of the 1^{st}-stage MSE 501 in molecular free path reaches a boiling point, and the liquid catalyst vaporizes to mist at the boiling point. Because the 1^{st}-stage MSE 501 is vacuumed by the external vacuum pump, a pressure difference passing through the conduit drops quickly, and molecules of the mist move to an outlet of a passage at a low pressure. When the molecules move to a central portion of the 1^{st}-stage MSE 501, they are stopped by a second condenser. Due to a temperature of a condensing tube of the second condenser is less than a water temperature, the molecules of the mist are condensed to convert into the fluid after contacting with the condensing tube, and the fluid drops into a fourth storage tank from an opening of the 1^{st}-stage MSE 501 temporarily so as to be delivered back to the liquidized catalyst tank 403, as shown in FIG. 5. A part of molecules of the mist flows into the cold well outside the 1^{st}-stage MSE 501 along a vacuum pipe so as to be condensed. Thereafter, the part of molecules drops into a first temporary recycle tank Z1 so as to be delivered into an external storage tank V5 after reaching the high fluid level.

Recycled oil, the base oil, the condensed oil, the diesel oil or oil based lubricant is not evaporated at a temperature of 60° C. and a pressure of 100 Pa, so it flows into an accommodation tank V1 along an opening of the 1^{st}-stage MSE 501 so as to be fed to the second molecular distilling. Furthermore, a part of the liquid catalyst in the first molecular distilling is not recycled and drops into the accommodation tank V1 to mix with the recycled oil or the oil based lubricant, thus producing mixing fluid.

The second molecular distilling is applied to avoid feeding the liquid catalyst increasingly after changing operation parameters so as to save production cost.

The second molecular distilling is identical to the first molecular distilling.

As illustrated in FIG. 6, in the second molecular distilling, a second preheater H4, the 2^{nd}-stage MSE 502, the cold well H6, the external vacuum pump VGA-1 and VGA-2 (spare), four receiving tanks V3, V4, V6, V7, four delivery pumps P4 to P7, and a recycled oil tank 503 are provided.

Furthermore, an ice water system 504 is provided in the liquid catalyst recycling step 50 so as to supply condensate water to the cold well to recycle the molecules of the mist. A cooling system 505 is configured to cool the condensate water, and a fluid heating system 506 is employed to produce water vapors, thus recycling a mixture of the recycled oil and flowing the liquid catalyst in the liquid catalyst recycling step 50.

With reference to FIGS. 1 and 7, the wastewater treatment step 60 is executed after the 3-phase cyclone separation step 20 so as to treat the waste water from the 3-phase cyclone separation step 20, thus avoiding pollution of the waste water.

An oil water separator 605, a micro filter 608, an ion-exchanger 611, a waste water buffer tank 601, a second temporary recycle tank 603, multiple feeding pumps 602, 604, 607, 610, and two activate carbon absorbent tanks 606, 609 are provided in the wastewater treatment step 60.

The waste water is delivered into the waste water buffer tank 601 from the 3-phase cyclone separation step 20, and after the waste water reaches the predetermined fluid level, it is pumped into and treated by the oil water separator 605 using a first feeding pump 604, and the waste water is fed into a first activate carbon absorbent tank 606 and is delivered into the micro filter 608 by a second feeding pump 607 after reaching the predetermined fluid level so as to remove oily drops less than 0.8 micron, then the waste water is guided into a second activate carbon absorbent tank 609 and is delivered into the ion-exchanger 611 by a third feeding pump 610 after reaching the predetermined fluid level, thus eliminating oil and odor.

In the 3-phase cyclone separation step 20, the waste water is vaporized to the water vapors at 135° C., so it is preferable to provide a water softener in the 3-phase cyclone separation step 20, thus pretreating the waste water. The waste water is delivered into a boiler so as to be heated, thus obtaining recycled water in the 3-phase cyclone separation step 20.

The mud homogenization step 10 is executed based on physical condition of the drilling mud, for example, when the drilling mud is liquid, the mud homogenization step 10 is eliminated so that the drilling mud is directly delivered to the 3-phase cyclone separation step 20 as follows.

As shown in FIGS. 1-7, the drilling mud is liquid and is with the oil-based drilling fluid, wherein the drilling mud is treated in following steps.

In the 3-phase cyclone separation step 20, the water vapors are used as a cleaning agent, for example, the drilling mud is flushed and is heated in the cyclone tank of the 3-phase separator 203 so as to dissolve the hydrocarbon and to evaporate the waste water and the petroleum gas, thus separating the oil, the water, the solid waste, and the petroleum gas.

In the petroleum gas oxidation and combustion step 30, the petroleum gas is extracted out of the 3-phase separator 203 by using the oil gas oxidation device 302, and the petroleum gas is thermal oxidized and combusted.

In the liquid catalyst extraction step 40, the solid waste in the 3-phase cyclone separation step 20 has the porous substances and the hydrocarbon of high viscosity, and the porous substances and the hydrocarbon are extracted out of the solid waste by using the microbubble extracting 41 of the liquid catalyst extraction step 40 and the liquid catalyst.

The liquid catalyst recycling step 50 has two-stage molecular distillation means (i.e., the first molecular distilling and the second molecular distilling) so as to recycle the liquid catalyst to the liquid catalyst extraction step 40 and to eliminate the liquid catalyst from the recycled base oil.

The wastewater treatment step 60 is executed after the 3-phase cyclone separation step 20 so as to treat the waste water from the 3-phase cyclone separation step 20, wherein the wastewater treatment step 60 includes the oil-water separating, the micro-filtrating and attaching, and the anion-cation exchanging so as to remove the hydrocarbon from the waste water completely, thus obtaining the recyclable effluent.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A method of treating drilling mud with oil-based drilling fluid comprising:
a mud homogenization step alternatively configured to homogenize drilling mud which is solidized mud;
a 3-phase cyclone separation step in which water vapors are used as a cleaning agent, wherein the drilling mud is flushed and is heated in a cyclone tank of a 3-phase separator so as to dissolve hydrocarbon and to evaporate waste water and petroleum gas, thus separating oil, water, solid waste, and the petroleum gas; wherein the mud homogenization step is executed based on physical condition of the drilling mud, when the drilling mud is liquid, the mud homogenization step is eliminated so that the drilling mud is directly delivered to the 3-phase cyclone separation step;
a petroleum gas oxidation and combustion step in which the petroleum gas is extracted out of the 3-phase separator by using an oil gas oxidation device, and the petroleum gas is thermal oxidized and combusted;
a liquid catalyst extraction step executed after the 3-phase cyclone separation step, wherein after separating oil and water, solid waste in the 3-phase cyclone separation step has porous substances and the hydrocarbon of high viscosity, and the porous substances and the hydrocarbon are extracted out of the solid waste by using a microbubble extracting of the liquid catalyst extraction step and liquid catalyst; and
a liquid catalyst recycling step having two-stage molecular distillation means so as to recycle the liquid catalyst to the liquid catalyst extraction step and to eliminate the liquid catalyst from recycled base oil.

2. The method as claimed in claim 1, wherein in the mud homogenization step, the drilling mud is fed into a grinder to be ground into particulars, and the particulars of the drilling mud are delivered into a buffer tank and are pumped to a blending tank by a first pump to homogenize the drilling mud; wherein when the drilling mud is solid in the mud homogenization step, condensed oil or diesel oil are added as grinding the drilling mud and mixing the particulars of the drilling mud; a second pump and a third pump deliver the condensed oil or the diesel oil to the grinder and the blending tank respectively from an oil tank.

3. The method as claimed in claim 1, wherein in the 3-phase cyclone separation step, the drilling mud is fed into a preheating tank so as to be heated by a heat pipe on a bottom of the preheating tank, then the drilling mud is delivered to the cyclone tank of a main unit of the 3-phase separator by a fourth pump; meanwhile, water vapors reversely flow into the cyclone tank so as to flush the drilling mud, and oily substances of the drilling mud suspend upward, thereafter the waste water is vaporized to the water vapors, and the water vapors revert into water after flowing through a condensation section of the 3-phase cyclone separator, the water is delivered to the wastewater treatment step by a fifth pump, hydrocarbon C1H4 to C3H8 of the petroleum gas converts into gas at 135° C. so as to suspend upward and to be vacuumed by a vacuum pump, hence the petroleum gas is drawn into a first condenser to be condensed and is pumped to the petroleum gas oxidation and combustion step via a vacuum tank.

4. The method as claimed in claim 3, wherein the solid waste accumulates on a bottom of the 3-phase separator in the 3-phase cyclone separation step so that after the bottom of the 3-phase separator turns on, the solid waste drops into a first storage tank, and recycled oil is fed into a recycled oil buffer tank so as to be delivered into a base oil tank after it is full of the recycled oil buffer tank.

5. The method as claimed in claim 1, wherein waste petroleum gas extracted out of the 3-phase cyclone separation step by using an exhauster of the oil gas oxidation device is guided into a refining gas buffer tank, and the waste petroleum gas is drawn into an oxidation tank of the oil gas oxidation device to be combusted and is discharged out of atmosphere via an discharge device.

6. The method as claimed in claim 5, wherein when an oxidation temperature of the petroleum gas does not reach a set temperature, an intake valve of the oil gas oxidation device turns on automatically so as to guide propane gas to mix with the waste petroleum gas, such that the waste petroleum gas is oxidized and combusted in the oil gas oxidation device so as to exhaust the petroleum gas.

7. The method as claimed in claim 1, wherein the residual solids discharged by the 3-phase separator is delivered to a dry cake buffer tank and is carried into a processing tank of a microbubble extractor via a conveyor, meanwhile, the liquid catalyst is added into the processing tank in a predetermined fluid level, and a microbubble generator is started to spray microbubbles out of a nozzle of the microbubble generator to flush the residual solids, hence a part of microbubbles in which the liquid catalyst is carried flows into bores of the solid waste, thus dissolving and washing the hydrocarbon of asphaltene and paraffin in the bores and producing mixture of the hydrocarbon and the liquid catalyst; thereafter, an eighth pump delivers the liquid catalyst into a washing tank of the microbubble extractor from a liquidized catalyst tank after feeding the solid waste continuously based on predetermined weight of the residual solids, wherein the mixture of the hydrocarbon and the liquid catalyst above a highest fluid level increases and overflows into a second storage tank, and a ninth pump pumps the mixture to a mixer buffer tank and is delivered to the liquid catalyst recycling step by a tenth pump.

8. The method as claimed in claim 1, wherein in the liquid catalyst recycling step, a 1^{st}-stage MSE and a 2^{nd}-stage MSE are provided in the first molecular distilling and the second molecular distilling respectively;
in the first molecular distilling, the tenth pump carries the liquid catalyst and recycled oil mixture to a first preheater so as to heat the liquid catalyst and recycled oil mixture, and the liquid catalyst and the recycled oil mixture enter into the 1^{st}-stage MSE so as to be scraped by a scraper of the 1^{st}-stage MSE into a film; since an external vacuum pump vacuums the 1^{st}-stage MSE via a conduit of a cold well, a pressure of the 1^{st}-stage MSE maintains so that a part of mixing fluid attaching on the film of an inner wall of the 1^{st}-stage MSE in molecular free path reaches a boiling point, and the liquid catalyst vaporizes to mist at the boiling point; the 1^{st}-stage MSE is vacuumed by the external vacuum pump, a pressure difference passing through the conduit drops quickly, and molecules of the mist move to an outlet of a passage at a low pressure; when the molecules move to a central portion of the 1^{st}-stage MSE, the molecules are stopped by a second condenser; a temperature of a condensing tube of the second condenser is less than a water temperature, the molecules of the mist are condensed to convert into the fluid after contacting with the condensing tube, and the fluid drops into a third storage tank from an opening of the 1^{st}-stage MSE temporarily so as to be delivered back to the liquidized catalyst tank;
the recycled oil of high boiling point is delivered to the second molecular distilling to avoid the liquid catalyst not being recycled completely in the first molecular distilling;
the second molecular distilling is identical to the first molecular distilling.

9. The method as claimed in claim 1 further comprising a wastewater treatment step which is executed after the 3-phase cyclone separation step, wherein the waste water from the 3-phase separator is treated in the wastewater treatment step, and the wastewater treatment step includes oil-water separating, micro-filtrating and attaching, and anion-cation exchanging so as to remove the hydrocarbon from the waste water completely, thus recycling the waste water;
wherein an oil water separator, a micro filter, an ion-exchanger, a waste water buffer tank, a second temporary recycle tank, and two activate carbon absorbent tanks are provided in the wastewater treatment step;
wherein the waste water is delivered into the waste water buffer tank from the 3-phase cyclone separation step, and after the waste water reaches a predetermined fluid level, the waste water is pumped into and treated by the oil water separator, and the waste water is fed into a first activate carbon absorbent tank and is delivered into the micro filter by after reaching the predetermined fluid level so as to remove oily drops, then the waste water is guided into a second activate carbon absorbent tank and is delivered into the ion-exchanger after reaching the predetermined fluid level.

10. A method of treating drilling mud with oil-based drilling fluid comprising:
a 3-phase cyclone separation step in which water vapors are used as a cleaning agent, wherein the drilling mud is flushed and is heated in a cyclone tank of a 3-phase separator so as to dissolve hydrocarbon and to evaporate waste water and petroleum gas, thus separating oil, water, solid waste, and petroleum gas;
a petroleum gas oxidation and combustion step in which the petroleum gas is extracted out of the 3-phase separator by using an oil gas oxidation device, and the petroleum gas is thermal oxidized and combusted;
a liquid catalyst extraction step executed after the 3-phase cyclone separation step, wherein after separating oil and water, solid waste in the 3-phase cyclone separation step has porous substances and the hydrocarbon of high viscosity, and the porous substances and the hydrocarbon are extracted out of the solid waste by using a microbubble extracting of the liquid catalyst extraction step and liquid catalyst; and
a liquid catalyst recycling step having two-stage molecular distillation means so as to recycle the liquid catalyst to the liquid catalyst extraction step and to eliminate the liquid catalyst from recycled base oil.

11. The method as claimed in claim 10, wherein in the 3-phase cyclone separation step, the drilling mud is fed into a preheating tank so as to be heated by a heat pipe on a bottom of the preheating tank, then the drilling mud is delivered to the cyclone tank of a main unit of the 3-phase separator by a fourth pump; meanwhile, water vapors reversely flow into the cyclone tank so as to flush the drilling mud, and oily substances of the drilling mud suspend upward, thereafter the waste water is vaporized to the water vapors, and the water vapors revert into water after flowing through a condensation section of the 3-phase cyclone separator, the water is delivered to the wastewater treatment step by a fifth pump, hydrocarbon C1H4 to C3H8 of the petroleum gas converts into gas at 135° C. so as to suspend upward and to be vacuumed by a vacuum pump, hence the petroleum gas is drawn into a first condenser to be condensed and is pumped to the petroleum gas oxidation and combustion step via a vacuum tank.

12. The method as claimed in claim 11, wherein the solid waste accumulates on a bottom of the 3-phase separator in the 3-phase cyclone separation step so that after the bottom of the 3-phase separator turns on, the solid waste drops into a first storage tank, and recycled oil is fed into a recycled oil buffer tank so as to be delivered into a base oil tank after it is full of the recycled oil buffer tank.

13. The method as claimed in claim 10, wherein waste petroleum gas extracted out of the 3-phase cyclone separation step by using an exhauster of the oil gas oxidation device is guided into a refining gas buffer tank, and the waste petroleum gas is drawn into an oxidation tank of the oil gas oxidation device to be combusted and is discharged out of atmosphere via an discharge device.

14. The method as claimed in claim 13, wherein when an oxidation temperature of the petroleum gas does not reach a set temperature, an intake valve of the oil gas oxidation device turns on automatically so as to guide propane gas to mix with the waste petroleum gas, such that the waste petroleum gas is oxidized and combusted in the oil gas oxidation device so as to exhaust the petroleum gas.

15. The method as claimed in claim 10, wherein the residual solids discharged by the 3-phase separator is delivered to a dry cake buffer tank and is carried into a processing tank of a microbubble extractor via a conveyor, meanwhile, the liquid catalyst is added into the processing tank in a predetermined fluid level, and a microbubble generator is started to spray microbubbles out of a nozzle of the microbubble generator to flush the residual solids, hence a part of microbubbles in which the liquid catalyst is carried flows into bores of the solid waste, thus dissolving and washing the hydrocarbon of asphaltene and paraffin in the bores and producing mixture of the hydrocarbon and the liquid catalyst; thereafter, an eighth pump delivers the liquid catalyst into a washing tank of the microbubble extractor from a liquidized catalyst tank after feeding the solid waste continuously based on predetermined weight of the residual solids, wherein the mixture of the hydrocarbon and the liquid catalyst above a highest fluid level increases and overflows into a second storage tank, and a ninth pump pumps the mixture to a mixer buffer tank and is delivered to the liquid catalyst recycling step by a tenth pump.

16. The method as claimed in claim 10, wherein in the liquid catalyst recycling step, a 1^{st}-stage MSE and a 2^{nd}-stage MSE are provided in the first molecular distilling and the second molecular distilling respectively;
in the first molecular distilling, the tenth pump carries the liquid catalyst and recycled oil mixture to a first preheater so as to heat the liquid catalyst and recycled oil mixture, and the liquid catalyst and the recycled oil mixture enter into the 1^{st}-stage MSE so as to be scraped by a scraper of the 1^{st}-stage MSE into a film; since an external vacuum pump vacuums the 1^{st}-stage MSE via a conduit of a cold well, a pressure of the 1^{st}-stage MSE maintains so that a part of mixing fluid attaching on the film of an inner wall of the 1^{st}-stage MSE in molecular free path reaches a boiling point, and the liquid catalyst vaporizes to mist at the boiling point; the 1^{st}-stage MSE is vacuumed by the external vacuum pump, a pressure difference passing through the conduit drops quickly, and molecules of the mist move to an outlet of a passage at a low pressure; when the molecules move to a central portion of the 1^{st}-stage MSE, the molecules are stopped by a second condenser; a temperature of a condensing tube of the second condenser is less than a water temperature, the molecules of the mist are condensed to convert into the fluid after contacting with the condensing tube, and the fluid drops into a third storage tank from an opening of the 1^{st}-stage MSE temporarily so as to be delivered back to the liquidized catalyst tank;
the recycled oil of high boiling point is delivered to the second molecular distilling to avoid the liquid catalyst not being recycled completely in the first molecular distilling;
the second molecular distilling is identical to the first molecular distilling.

17. The method as claimed in claim 10 further comprising a wastewater treatment step which is executed after the 3-phase cyclone separation step, wherein the waste water from the 3-phase separator is treated in the wastewater treatment step, and the wastewater treatment step includes oil-water separating, micro-filtrating and attaching, and anion-cation exchanging so as to remove the hydrocarbon from the waste water completely, thus recycling the waste water;
wherein an oil water separator, a micro filter, an ion-exchanger, a waste water buffer tank, a second temporary recycle tank, and two activate carbon absorbent tanks are provided in the wastewater treatment step;
wherein the waste water is delivered into the waste water buffer tank from the 3-phase cyclone separation step, and after the waste water reaches a predetermined fluid level, the waste water is pumped into and treated by the oil water separator, and the waste water is fed into a first activate carbon absorbent tank and is delivered into the micro filter by after reaching the predetermined fluid level so as to remove oily drops, then the waste water is guided into a second activate carbon absorbent tank and is delivered into the ion-exchanger after reaching the predetermined fluid level.
